(19) United States
(12) Patent Application Publication
(10) Pub. No.: US 2014/0121937 A1
(43) Pub. Date: May 1, 2014

(54) DIGITAL SIGNAL TO ANALOG SIGNAL GAUGE ADAPTER

(71) Applicants: Michael Drew, Dexter, MI (US); Brian Herron, Dexter, MI (US)

(72) Inventors: Michael Drew, Dexter, MI (US); Brian Herron, Dexter, MI (US)

(21) Appl. No.: 14/064,435

(22) Filed: Oct. 28, 2013

Related U.S. Application Data
(60) Provisional application No. 61/719,001, filed on Oct. 26, 2012.

(51) Int. Cl. F02D 29/02

(52) U.S. Cl. CPC F02D 29/02
USPC 701/101

(57) ABSTRACT

A system for detecting and converting vehicle information for display includes a device including a first port and a second port. The first port being configured for communicating with a port of a vehicle to receive an input signal and the second port being configured for communicating an output signal from the device to a gauge. The system also includes a processor operatively coupled to the device. The processor is in communication with the first port and the second port is configured to read data from the input signal received at the first port, convert the data from the input signal to the output signal, wherein the output signal has an analog format, and output the output signal from the second port to drive at least one vehicle gauge.

### CROSS REFERENCE TO RELATED PATENT APPLICATION

This application claims priority to U.S. Provisional Patent Application 61/719,001, which is hereby incorporated by reference in its entirety.

### BACKGROUND

1. Field of the Invention

The present invention generally relates to systems for detecting and converting vehicle information for display.

2. Description of Related Art

When new cars are built, many automakers limit the number of gauges on the vehicle's factory dashboard to save cost and simplify things for the driver. This can be a problem for some drivers that want to see additional gauges to help them confirm that the vehicle is operating safely and within its designed limits.

For this reason, many drivers install aftermarket gauges in their vehicle after they purchase it. While there are several different options offered, the most popular are round gauges with mechanical needles that move. The installation of these aftermarket gauges can be costly and time consuming because it requires the installation of a sender unit for each gauge.

One example is a driver that purchases a new truck. If they are towing heavy loads, they may want to monitor transmission temperature and exhaust gas temperature. After purchasing a brand new vehicle, they will have to modify it to install aftermarket gauges. They will be required to drill into the exhaust manifold to install an EGT probe and cut the transmission lines to install a transmission temp probe.

This is not desirable for several reasons. First, the modification of the vehicle to accept these new senders can void the factory warranty on a new vehicle. Second, the installation can take several hours and require wires to be routed thru the vehicle's firewall. Lastly, the quality of the installation and wiring will affect the reliability.

While many drivers are installing aftermarket senders, most do not realize that the car's engine system already has most of those sensors already installed. Even though a vehicle's factory dashboard does not display readings from every sensor, the car's onboard computer system does measure those sensors as it manages the engine controls. These factory onboard sensors may not be externally accessible. For example, a transmission sensor may be installed inside the transmission valve body and not accessible from the exterior of the transmission.

### SUMMARY

A system for detecting and converting vehicle information for display includes a device including a first port and a second port. The first port being configured for communicating with an output port (which may be a bi directional port) of a vehicle to receive an input signal The second port being configured for communicating an output signal from the device to a gauge. The system also includes a processor operatively coupled to the device. The processor is in communication with the first port and the second port is configured to read data from the input signal received at the first port, convert the data from the input signal to the output signal, wherein the output signal has an analog format, and output the output signal from the second port to drive at least one vehicle gauge.

Further objects, features and advantages of this invention will become readily apparent to persons skilled in the art after a review of the following description, with reference to the drawings and claims that are appended to and form a part of this specification.

### BRIEF DESCRIPTION OF THE DRAWINGS

FIG. 1 illustrates a block diagram of a vehicle and more particularly the electronic systems of a vehicle;

FIG. 2 illustrates a block diagram of the system for converting data from the electronic control unit of the vehicle of FIG. 1 to a configurable analog format;

FIG. 3 illustrates the system of FIG. 2 connected to a computer to configure the operation of the system; and

FIG. 4 illustrates a display that may be connected to the system of FIG. 2 to display information.

### DETAILED DESCRIPTION

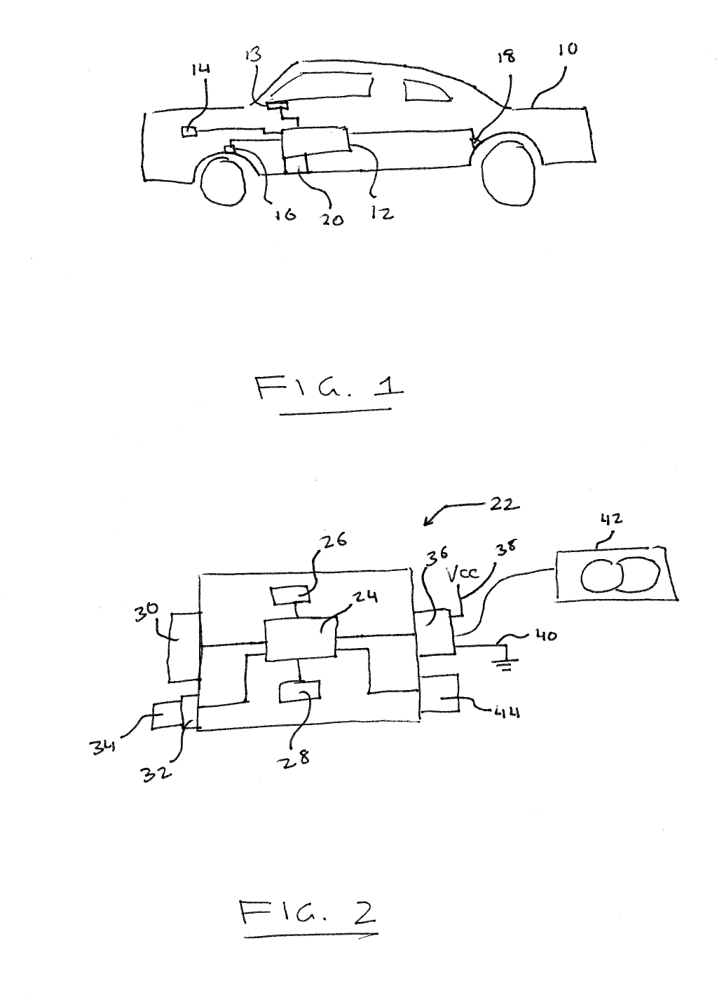

Referring now to FIG. 1, a vehicle 10 is shown. The vehicle 10 in this embodiment is an automobile, but may be any type of vehicle having an Electronic Control Unit (“ECU”) including, but not limited to cars, trucks, heavy duty trucks, commercial vehicles, construction equipment, boats, airplanes, or any other vehicle capable of transporting persons and items from one point to another.

As its primary components, the vehicle 10 includes an electronic ECU 12. The ECU 12 of the vehicle 10 may include one or more controllers to control various systems of the vehicle 10. For example, the ECU 12 of the vehicle may control the engine, transmission, vehicle safety systems, tire pressure monitoring, or other vehicle subsystems.

As such, in order to control these various subsystems, the ECU 12 may be connected to a number of sensors capable of sensing information from the subsystem in which they control. For example, the vehicle 10 may include an engine monitoring sensor 14 which monitors the engine and/or transmission of the vehicle. Of course, the sensor 14 may be more than one sensor may be a plurality of different sensors spread throughout the car to monitor the engine and/or transmission of the vehicle 10. The ECU may also be connected to safety system sensor 16 which could be used to monitor the safety systems of the vehicle, such as airbag deployment, wheel speed, brakes, or other systems. Like before, the sensor 16 may be more than one sensor used to monitor a variety of different subsystems, such as exhaust and vehicle emissions as well.

Additionally, the sensors located in the vehicle 10 are not limited to just those described in the sentences above. Other sensors 18 may also be incorporated within the vehicle to monitor a variety of different subsystems as well. Like before, the sensor 18 may be a variety and a plurality of different sensors to monitor these various subsystems. The sensors 14, 16, and 18 are connected to the ECU 12 through either a direct connection or via a bus such as a Controller Area Network (“CAN”) bus.

The ECU 12 of the vehicle may also include a port 20 that allows external systems to communicate with the ECU 12 of the vehicle 10. This port may be known as an on-board diagnostic port commonly referred to as OBD2 port. These ports are commonly found in all automobiles manufactured and sold in the United States today and can be used for a variety of uses, such as reprogramming the ECU 12 of the vehicle 10 or receiving information from the ECU 12 of the vehicle 10. Finally, a display device 13, such as a digital or analog cluster may be connected to the ECU 12.

Referring to FIG. 2, a system 22 configured to read data from the ECU12 of the vehicle 18 and convert the data from the ECU 12 of the vehicle 10 to configurable analog format is shown. As its primary components, the system includes a controller 24. The controller 24 may be in communication with a first memory unit 26 and a second memory unit 28. However, it should be understood that the controller 24 may incorporate the memory units 26 and 28 or alternatively the memory units 26 and 28 may be combined in a single unit separate from the controller 24.

The system 22 also includes a port 30 that is configured to mate with the port 20 of FIG. 1. As mentioned when describing port 20 of FIG. 1, the port 30 may be an OBD2 style port that is configured to connect with an OBD2 style port of the vehicle 10.

The system 22 may also include a memory interface 32 that is in communication with the controller 24. The memory interface 32 may be a card style slot for receiving external storage devices, such as a Secure Digital (“SD”) card 34. When an SD card 34 is inserted into the memory unit 32, the SD card 34 will then be in communication with the controller 24. Of course, any one of a number of different storage devices may be utilized and should not be limited to just SD cards.

The system 22 may also include the second port 36. The second port 36 outputs data from the ECU 12 that has been converted to a configurable analog format. The port 36 may be a powered port and may include a voltage source 38 and a ground 40 so as to provide power to any devices that are connected to the second port 36. For example, the external device 42 may be an analog gage cluster or could also be a digital readout.

The system 22 may also include a third port 44 that is in communication with the controller 24. The third port 44 can be any one of variety of different ports that allows the connection of an external device, such as a personal computer, electronic tablet, mobile phone, or the like to the system 22. Of course, the third port 44 may be a wireless interface that allows wireless communication between the system 22 and a personal computer, electronic tablet, mobile phone, or the like. Generally, the port 44 may be a USB port but may also be an Ethernet type port or may additionally be a wireless transceiver such as an IEEE 802.11 transceiver.

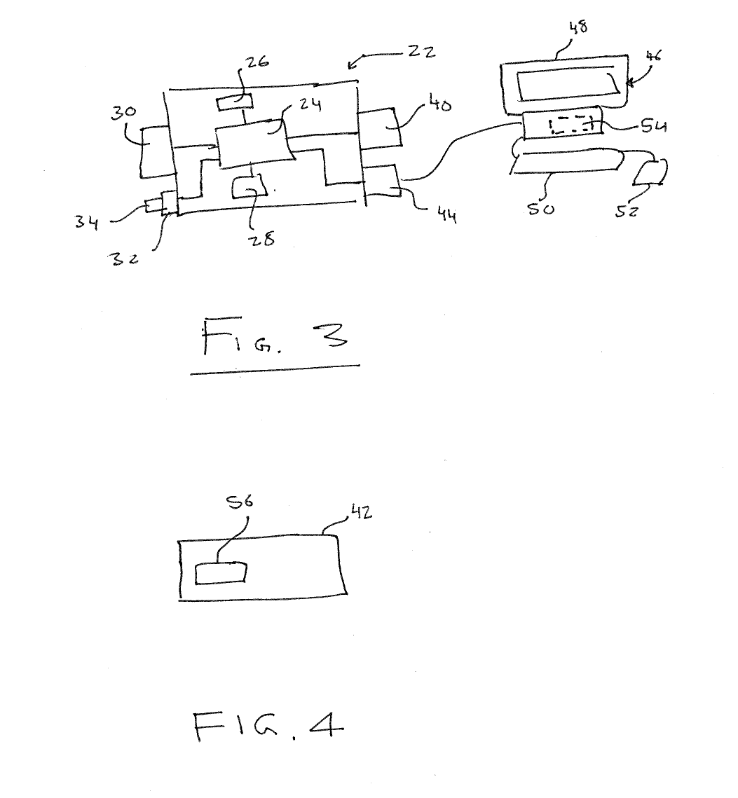

Referring to FIG. 3, the system 22 is shown connected to an external device such as a personal computer 46. It should be understood that the personal computer 46 may be a general purpose personal computer, electronic tablet, mobile phone, or the like. The computer 46 may have a display 48 and inputs in the form of a keyboard 50 and/or mouse 52. Of course, any one of a number of different input devices can be used such as touch screens where even voice input command interfaces.

The processor 24 of the system 22 is configured via the use of software or firmware which may be stored on a processor 24, memory devices 26 and 28, or even the SD card 34. The software configures the processor 24 to perform a number of different functions. For example, the software configures the processor to read data from the ECU 12 of the vehicle via the port 30 and convert the data from the ECU 12 to a configurable analog format and then output the configurable analog format to the second port 40 to drive at least one analog gage 42 of FIG. 2.

The operating perimeters of the system may be established by connecting the system 22 to the computer 46 that configures the operation of the system 22 using software 54 that operates on the computer 46. Of course, the operating perimeters may be previously set by the manufacturer or may be configurable to the use of the SD card 34. The operating perimeters may be combined mathematically to synthesize a new perimeter and use that to drive the analog gage 42 or possibly a relay.

In particular, the new parameter may be able to calculate fuel economy from varies engine perimeters received from the sensors 14, 16, and/or 18. These perimeters will drive the analog gage 42 and may result with the result or possibly light a lamp on the analog gage 42 when the fuel economy is below a certain predetermined threshold. This predetermined threshold may be set by the system 22 or may be modified by the computer 46.

Referring to FIG. 4, the display 42 may, instead of or in addition to displaying analog gages may simply be an LCD type readout or similar. The display 42 can then display one of any one of a number of different images, such as gages, symbols, light patterns or others, as indicated by element 56. For example, the output of the system 22 may be used to eliminate a check engine lamp.

As explained above, the output 40 of the system 22 may be used to drive the display 42 or a relay when a perimeter is either above or below a certain value. The system 22 may be adapted to be configured to activate a lamp when a perimeter or threshold is above or below a certain value. For example, the display 42 may be able to illuminate a “shift light” when the RPM exceeds a certain preset value. The RPM of the automobile can be determined by monitoring sensor 14 via the ECU 12.

The system 10 can also be used to illuminate a lamp such as an “oil light” lamp when the engine oil pressure is below a certain preset value. As explained before, the engine oil pressure can be determined by monitoring sensor 14 via the ECU 12.

In addition, the SD card 34 may be in communication with the processor 24 and may be logging data received from the port 20 from the ECU 12. The SD card 34 may be later removed for analysis by a user.

As a person skilled in the art will readily appreciate, the above description is meant as an illustration of implementation of the principles this invention. This description is not intended to limit the scope or application of this invention in that the invention is susceptible to modification, variation and change, without departing from the spirit of this invention, as defined in the following claims.

1. A system for detecting and converting vehicle information for display, the system comprising:
a device including a first port and a second port, the first port being configured for communicating with an port of a vehicle to receive an input signal, the second port being configured for communicating an output signal from the device to a gauge;
a processor operatively coupled to the device, the processor being in communication with the first port and the second port and being configured to read data from the input signal received at the first port, convert the data from the input signal to the output signal, wherein the output signal has an analog format, and output the output signal from the second port to drive at least one vehicle gauge.

2. The system of claim 1, wherein the first port is configured for communicating with an OBD2 port of a vehicle.

3. The system of claim 2, wherein the OBD2 port is in communication with an electrical control unit of a vehicle.

4. The system of claim 1, wherein the output signal is in a configurable analog format.

5. The system of claim 4, wherein the at least one gauge is an analog gauge.

6. The system of claim 1, wherein the output signal is in an analog electrical format.

7. The system of claim 6, wherein the at least one gauge is an electrical gauge.

8. The system of claim 1, wherein the input signal comprises sensor values received from an onboard computer system of the vehicle.

9. The system of claim 1 further comprising operating parameters operatively coupled to the processor for configuring the operation of the system to convert the input signal to the output signal.

10. The system of claim 9, wherein the operating parameters of the system are received from a personal computer program operatively coupled to the device that configures the operation of the system.

11. The system of claim 9, wherein the operating parameters are combined mathematically to synthesize a new parameter, and the new parameter drives the at least one vehicle gauge.

12. The system of claim 11, wherein the new parameter calculates fuel economy from various operating parameters and the output signal is configured to activate a lamp when fuel economy is below a predetermined threshold.

13. The system of claim 1, wherein the output signal is configured to activate a check engine lamp.

14. The system of claim 1, wherein the output signal drives a relay when a parameter is above a certain value.

15. The system of claim 1, the output signal drives a relay when a parameter is below a certain value.

16. The system of claim 1, wherein the output signal activates a lamp when a parameter threshold is above a certain value.

17. The system of claim 16, wherein the lamp is a “shift light” when RPM exceeds a certain preset value.

18. The system of claim 1, wherein the output signal activates a lamp when a parameter threshold is below a certain value.

19. The system of claim 18, wherein the lamp is an “oil light” when engine oil pressure is below a certain preset value.

20. The system of claim 1, wherein the processor is pre-programmed to support predetermined functions or gauges out of the box.

21. The system of claim 1, further comprising an external storage interface, wherein the external storage interface is in communication with the processor and an internal storage device for later retrieval and analysis by the user.

22. The system of claim 1, further comprising a wiring harness connected to the device and having an analog communication connection, a power connection, and a ground connection.

23. The system of claim 22, wherein the wiring harness provides the output signal for the at least one gauge.

24. The system of claim 23, wherein the wiring harness provides the input signal from the vehicle to the first port.
